(19) United States
(12) Patent Application Publication
(10) Pub. No.: US 2005/0082234 A1
(43) Pub. Date: Apr. 21, 2005

(54) Device and method for siezing,sizing, sifting, filtering or sorting substances

(76) Inventor: Jurg Solenthaler, Bronschhofen (CH)

Correspondence Address: SHOEMAKER AND MATTARE, LTD, 10 POST OFFICE ROAD - SUITE 110, SILVER SPRING, MD, 20910, US

(21) Appl. No.: 10/362,520

(22) PCT Filed: Aug. 16, 2001
(86) PCT No.: PCT/EP01/09424

(30) Foreign Application Priority Data
Sep. 4, 2000 (EP) 008107914
Nov. 8, 2000 (EP) 001242007

(51) Int. Cl. B03C 1/00; B01D 33/03

(52) U.S. Cl. 210/748; 210/785; 210/388

(57) ABSTRACT

Particles (P) contained in a liquid are sieved by placing them onto a sieving surface (3) located inside a sieving frame (2). The sieving process ensues by subjecting the liquid (F) to ultrasonic oscillations (U). The ultrasonic oscillations (U) are generated using an ultrasonic device (4) having an ultrasonic irradiation surface (5) that can be brought into contact with the liquid (F). At least one ultrasonic transducer (6) is arranged on the side (7) of said ultrasonic irradiation surface that faces away from the liquid. The ultrasonic device (4) comprises an approximately conical ultrasonic irradiation surface (5).

The invention relates to a device and a process for screening, classifying, sifting, filtering or sorting of substances with the features of the preamble of the independent claims.

It is known that ultrasonic vibrations benefit screen feed in a screening machine. The vibrating motions can reduce agglomeration forces and surface tensions and thus reduce or prevent the danger of clogging of the screening meshes.

WO 94/27748 discloses for example providing a screening cloth with a resonator with finger-like resonator rods so that ultrasonic vibrations are distributed as much as possible over the entire screening cloth. While this arrangement works satisfactorily in conjunction with dry screen feed, problems arise to some extent in screening of particles held in liquids. It is especially due to the fact that the liquid comparatively strongly attenuates the ultrasonic vibrations on the cloth so that in spite of the resonator rods parts of the screening cloth are not exposed to vibrations. The designations screening/screen are used in a standard manner here and hereinafter, and any treatment of the material, especially also classification, sifting, filtering or sorting are to be encompassed by this concept.

Various devices are known for screening of particles held in liquids with ultrasound.

U.S. Pat. No. 4,693,879 teaches mounting an ultrasonic sonotrode adjacent to the surface of a revolving screen. One disadvantage in this arrangement is that the entire screen surface cannot be exposed to ultrasound. For this reason only one part of the screen surface at a time can be actively used.

U.S. Pat. No. 4,282,100 likewise proposes use of a revolving screen. The material to be screened is routed through a gap between the sonotrode and the screen surface. Here too only a limited part of the screen surface can be actively used.

U.S. Pat. No. 3,490,584 shows a conventional screening machine in which the liquid held on the screening cloth is exposed to ultrasonic vibrations by means of an ultrasonic sonotrode. As a result of the limited dimensions of the sonotrode it is however necessary to rotate the screening machine in order to expose the entire screen surface to ultrasonic vibrations. The screening machine with a rotary drive is therefore complex in its construction.

U.S. Pat. No. 3,756,400 discloses inserting an ultrasonic sonotrode into a tubular container in which the liquid to be screened and the screening cloth are contained. One disadvantage in this arrangement is that as a result of the limited cross section of the sonotrode only relatively small screen surfaces can be used.

The object of this invention is to avoid the disadvantages of what is known, especially therefore to devise a device and a process for screening of particles which are contained in the liquid, with which in a structurally simple manner essentially the entire screen surface can be exposed to ultrasound. In doing so if possible rotating screen arrangements will be avoided. The device as claimed in the invention should moreover be easily applicable to existing screening machines. Another object of the invention is to increase the efficiency of exposure to ultrasound. Still another object is to increase the ultrasonic energy which can be delivered into the liquid. The device will moreover allow reliable operation; especially the destruction of the ultrasonic arrangement by overload, for example with overly small amounts of the screen feed, will be avoided.

These objects are achieved as claimed in the invention with a device and a process with the features of the characterizing part of the independent claims.

The device for screening of particles contained in a liquid has at least one screen frame with a screen surface. The liquid with the particles to be screened can be applied to the screen surface. The device moreover has at least one ultrasonic arrangement for delivering ultrasonic vibrations into the liquid. The ultrasonic arrangement has an acoustic irradiation surface which can be brought into contact with the liquid on the screen surface. The acoustic irradiation surface can be caused to vibrate with at least one ultrasonic transducer. The ultrasonic transducer is preferably located on the side of the acoustic irradiation surface facing away from the liquid.

As claimed in the invention the ultrasonic arrangement is therefore made as a so-called immersible transducer. One or more ultrasonic transducers produce ultrasonic vibrations on an acoustic irradiation surface which is typically made as a sheet. The acoustic irradiation surface which vibrates overall can be brought into contact with the liquid which contains particles. Thus essentially the entire liquid contained on the screen surface can be exposed to sonic waves. In doing so the liquid is exposed to sonic waves directly from overhead, i.e. not via the screen surface. With these immersible transducers it is moreover possible to deliver much higher ultrasonic energies into the liquid than with ultrasonic sonotrodes, typically up to 10 kW.

Because the liquid with the particles which are to be screened is to a certain extent squeezed between the screen surface and the acoustic irradiation surface, in addition a static pressure forms which can have a positive effect on the screening properties.

According to one preferred embodiment therefore the acoustic irradiation surface covers essentially the entire screen surface.

The screen surface is typically made roughly round (as in conventional screening machines). The ultrasonic arrangement is made roughly rotationally symmetrical with respect to the axis perpendicularly to the screen surface. Typically the ultrasonic arrangement can be made hexagonal.

Advantageously the ultrasonic arrangement has a feed opening. The feed opening is preferably arranged centrally. This makes it possible to feed the liquid roughly into the center of the screen surface through the ultrasonic arrangement located above the screen surface.

According to one especially preferred embodiment a gap is formed between the screen surface and the acoustic irradiation surface; the distance of the gap from the feed opening for the liquid with the particles diminishes toward a discharge opening for material which cannot be screened. In the operation of the device, as a result of the newly supplied liquid, the liquid to be screened is moved from the feed opening towards the discharge opening. The angle between the acoustic irradiation surface and the screen surface and/or the width of the gap can be made adjustable.

Due to the vibrating motion of the screening machine the screen feed is conveyed to the outside by centrifugal forces. The static pressure of the screen feed slightly compresses it as the gap width is reduced. This ensures that the acoustic irradiation surface always remains in contact with the screen feed.

A radially symmetrical ultrasonic arrangement is especially preferred in which the gap between the screen surface and the acoustic irradiation surface decreases continuously from the center of the ultrasonic arrangement towards the outer edge. The acoustic irradiation surface is therefore made roughly conical, and for structural reasons a structure of flat component pieces is conceivable.

Advantageously the screen frame is provided with at least one lateral discharge opening for material which cannot be screened. Material which has not yet been screened when the edge of the screen is reached is discharged through the discharge opening, to a certain extent scoured by the liquid. Thus continuous operation of the device as claimed in the invention is possible.

So that the ultrasonic arrangement can be used on conventional screening machines, it is advantageously made for detachable connection to the outside wall (top cover) of a conventional screening machine.

In order to prevent overloading of the ultrasonic arrangement, the device can be provided preferably with means for measuring and/controlling the level of the liquid on the screen surface. Thus it is possible to prevent the acoustic irradiation surface from moving completely or partially out of contact with the liquid and thus undamped operation from occurring. To measure the level a measurement sensor can be used. The level however can be determined indirectly especially advantageously via the load of the generator for the ultrasonic arrangement.

According to one preferred embodiment a so-called static screening machine can be used. The screening cloth is located at an angle to the horizontal (in the operating position of the screen feed) so that the screen feed moves down over the screen surface as a result of gravitation.

The acoustic irradiation surface is located at an angle to the screen surface. The distance between the acoustic irradiation surface and screen surface decreases downward.

In this embodiment there can be one or more ultrasonic arrangements.

The acoustic irradiation surfaces are each made flat, and the angle and/or the distance between the acoustic irradiation surface and the screen surface can also be adjustable.

According to another alternative embodiment the screen surface of the device can be advantageously located to be movable relative to at least one ultrasonic arrangement. The acoustic irradiation surface can preferably be located at an angle to the screen surface. In this way the width of the gap between the screen surface and the acoustic irradiation surface decreases from material feed to material discharge. The screen surface can advantageously be moved in the direction between material feed and material discharge. This yields various advantages. By moving the screen surface and thus also the screen feed in the direction of the narrowing gap, pressure is additionally produced on the screen feed. In this way the ultrasonic action is increased. At the same time large particles which cannot be screened are discharged by the motion of the screen. Accumulation of particles which cannot be screened is this prevented.

It is advantageous to make the screen surface as a closed, flexible screen which is clamped on two rotationally supported rollers.

Therefore the invention consists among others in using an immersible transducer (known for example from ultrasonic cleaning) for exposing the screen feed in liquids to sonic waves. In this connection liquid with particles is defined as all flowable media which contain particles to be screened, therefore typically dispersions, and the actual liquid portion can be so small that the liquid to be treated has a sludge-like consistency.

### The invention is detailed below in embodiments and using drawings.

FIG. 1 shows a cross section through a device as claimed in the invention,

FIG. 2 shows a perspective of an ultrasonic arrangement as claimed in the invention,

FIG. 3 shows an overhead view of the ultrasonic arrangement as shown in FIG. 2,

FIG. 4 shows an enlargement of one extract from FIG. 1, and

FIGS. 5 and 6 show schematics of two alternative embodiments.

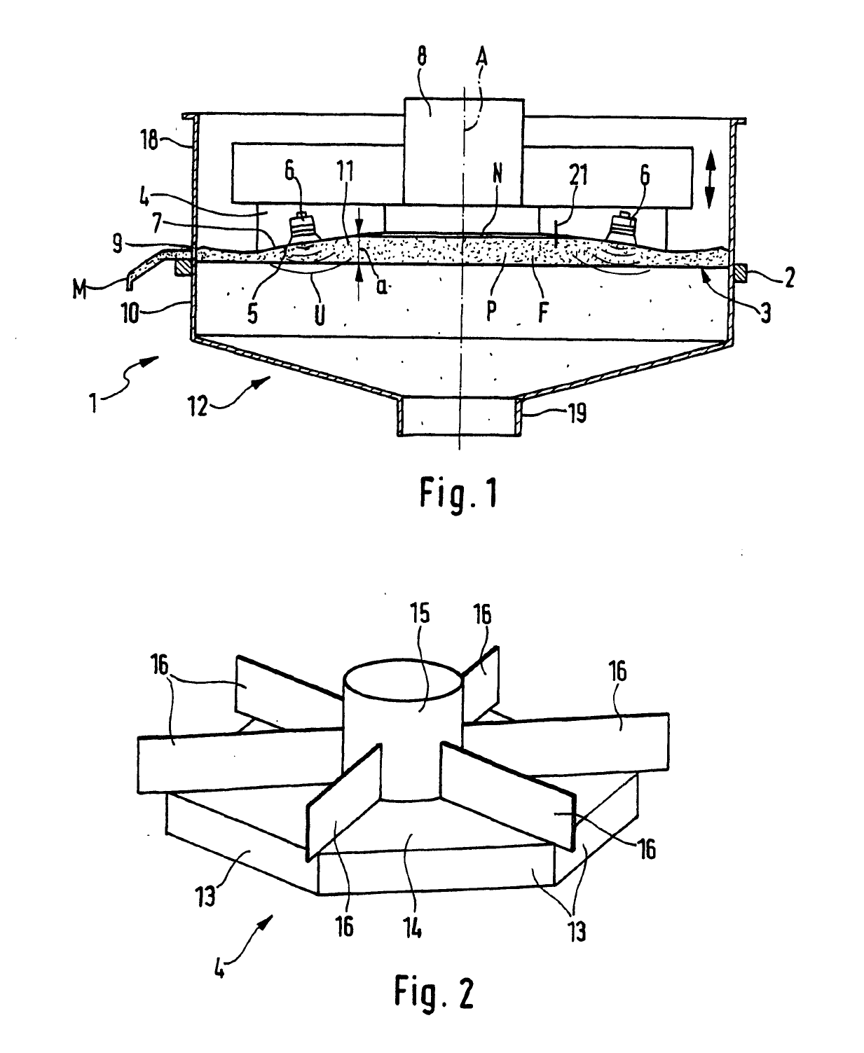

FIG. 1 shows a device 1 which is used for screening of particles P which are contained in a liquid F. The device 1 has a screen frame 2 which bears a screen surface 3. The screen surface 3 is typically a known screening cloth. The screen frame 2 and the screen surface 3 form part of a conventional screening machine 12. The screening machine 12 is of conventional design and is made as a disk, vibration or shaking screening machine.

Above the surface 3 as claimed in the invention there is a ultrasonic arrangement 4. The ultrasonic arrangement 4 is made like a conventional immersible transducer and has an acoustic irradiation surface 5. On the side 7 facing away from the acoustic irradiation surface there are twelve ultrasonic transducers 6. The ultrasonic arrangement 4 is made as a closed box, with ultrasonic transducers 6 located on its inside 7 (see also FIG. 4). The acoustic irradiation surface 5 of the ultrasonic arrangement 4 can be brought into contact with the liquid F which contains the particles P. In this way ultrasonic vibrations U can be delivered into the liquid F via the acoustic irradiation surface 5.

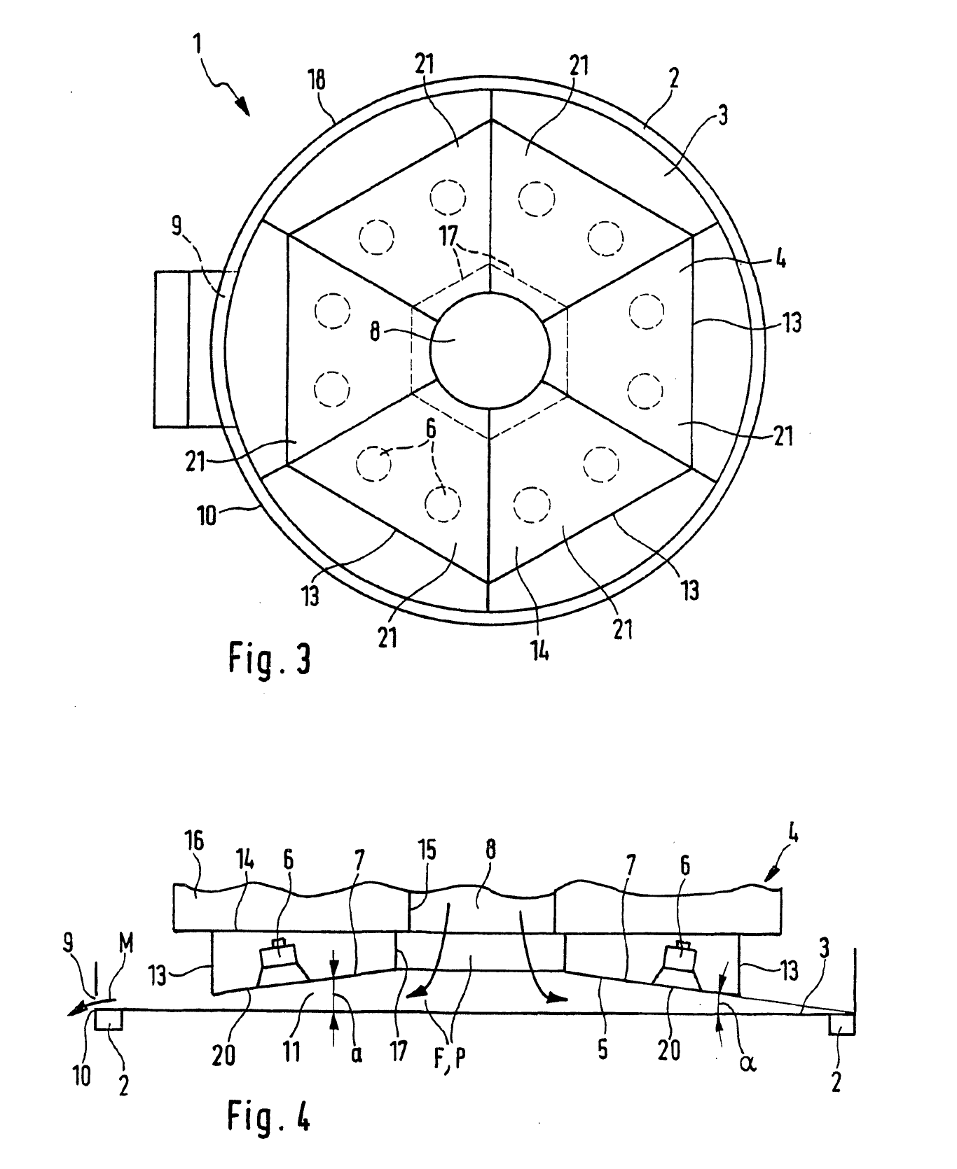

The ultrasonic arrangement 4 is made rotationally-symmetrical with respect to the axis A perpendicularly to the screen surface 3. The construction is typically hexagonal (see FIG. 2 or 3). One such hexagonal construction is recommended for structural reasons. Of course also round arrangements or polygonal arrangements with more or less than six corners would be conceivable. In the middle the ultrasonic arrangement 4 is provided with a feed opening 8 by which material to be screened can be applied to the screen surface 3.

The ultrasonic arrangement 4 is held in a round outside wall 18. The outside wall 18 (top cover) is part of the screening machine 12. In the screen frame 2 or in the outside wall 18 there is an opening 9. Material M which has not been screened or which cannot be screened can be discharged through the opening 9.

The acoustic irradiation surface 5 of the ultrasonic arrangement 4 is tilted with respect to the screen surface 3 at an angle α of roughly 10° (see FIG. 4) so that between the screen surface 3 and the acoustic irradiation surface 5 a narrowing gap 11 is formed. The distance a between the screen surface 3 and the acoustic irradiation surface 5 decreases continuously from the middle of the ultrasonic arrangement 4 towards the outer edge 10. The distance a can also be adjustable, for example by adjustable mounting of the ultrasonic arrangement 4 on the screening machine 12.

During operation the material to be screened (liquid F with particles P) is delivered onto the screen surface 3 in the middle of the ultrasonic arrangement 4. Screenable material passes through the screen surface 3 and is removed from the screening machine 12 by a drain 19. Material which has not been screened or which cannot be screened moves radially to the outside as a result of the newly supplied screen feed and screening machine vibrations. Material which has not yet been screened when the outer edge 10 is reached is discharged through the discharge opening 9.

The liquid F contained on the screen surface 3 has a certain level N. To prevent the ultrasonic arrangement 4 from operating without a load and thus being destroyed, it must be ensured that the level N of the liquid F does not drop below a predetermined value. For this reason there is a measurement sensor 12 which is shown schematically and which measures the level N. As soon as the level N drops below a setpoint, the ultrasonic generator is stopped and/or addition screen feed is added. But it is also conceivable to determine the level N via the load of the generator for the ultrasonic transducer 6.

FIG. 2 shows the construction of an ultrasonic arrangement 4. The ultrasonic arrangement 4 is made as a box.

The rear wall 14 of the box-shaped ultrasonic arrangement 4 is provided moreover with reinforcing or holding sheets 16 which are arranged in a star-shape around the supply pipe 15 for the screen feed (FIGS. 2 and 3). The ultrasonic arrangement is preferably detachably connected to the outside wall 18 via the holding sheets 16. The holding sheets 16 can be adjustably connected to the outside wall 18 so that the distance a can be set. By choosing the size of the holding sheets 16, the ultrasonic arrangement can be matched to the dimension of the screen frame 2. The box-shaped ultrasonic arrangement 4 is welded tight against the outside. On the side 7 of the acoustic irradiation surface 5 facing away from the liquid F there are ultrasonic transducers 6 (see FIG. 1). The power supply (not shown) for the ultrasonic transducer is routed out through the surface of the box (for example through the back).

The box-like ultrasonic arrangement 4 is bordered on the outside by six side walls 13 and on the inside by six inside walls 17 (see FIGS. 3 and 4). As a continuation of the round feed opening 8 on the back wall, the feed pipe 15 is on the back wall 14, by which pipe the material to be screened can be introduced.

The box contains six component surfaces 20 which together form the acoustic irradiation surface 5 (see FIGS. 3 and 4). The component surfaces 20 are each made trapezoidal. Two component surfaces 20 next to one another at a time are welded to one another along their sides, the component surfaces 20 not lying in the same plane so that the acoustic irradiation surface 5 has an overall somewhat conical shape (see FIG. 4).

FIG. 3 shows the hexagonal execution of the ultrasonic arrangement 4. The holding sheets 16 join the arrangement 4 to the outside wall 18. The outside wall is made round and forms part of the screening machine. The ultrasonic arrangement 4 has a somewhat smaller dimension than the screen frame 2 and is bordered on the outside by the side walls 13 and is made hexagonal. The round feed opening 8 in the back wall 14 of the ultrasonic device 4 is made smaller relative to the inside walls 17. The inside walls 17 together likewise form a hexagon.

FIG. 4 shows an enlarged extract from FIG. 1, for reasons of clarity the liquid F with the particles P which are to be screened not being shown.

FIG. 4 shows the arrangement of the individual component surfaces 20 in various planes which leads to a somewhat conical shape of the acoustic irradiation surface 5.

The ultrasonic transducers 6 is typically twelve piezoelectric transducers. The piezoelectric transducers 6 are cemented to the side 7 of the ultrasonic arrangement 4 facing away from the liquid. The ultrasonic transducers 6 are operated at a frequency of roughly 30 kHz parallel to one another with a conventional ultrasonic generator. A power of up to 0.6 kW can be delivered into the liquid F with the twelve transducers 6 shown here.

The box-shaped ultrasonic arrangement 4 consists of parts of stainless chromium steel (1.4301) welded to one another, with a thickness of typically 2 mm.

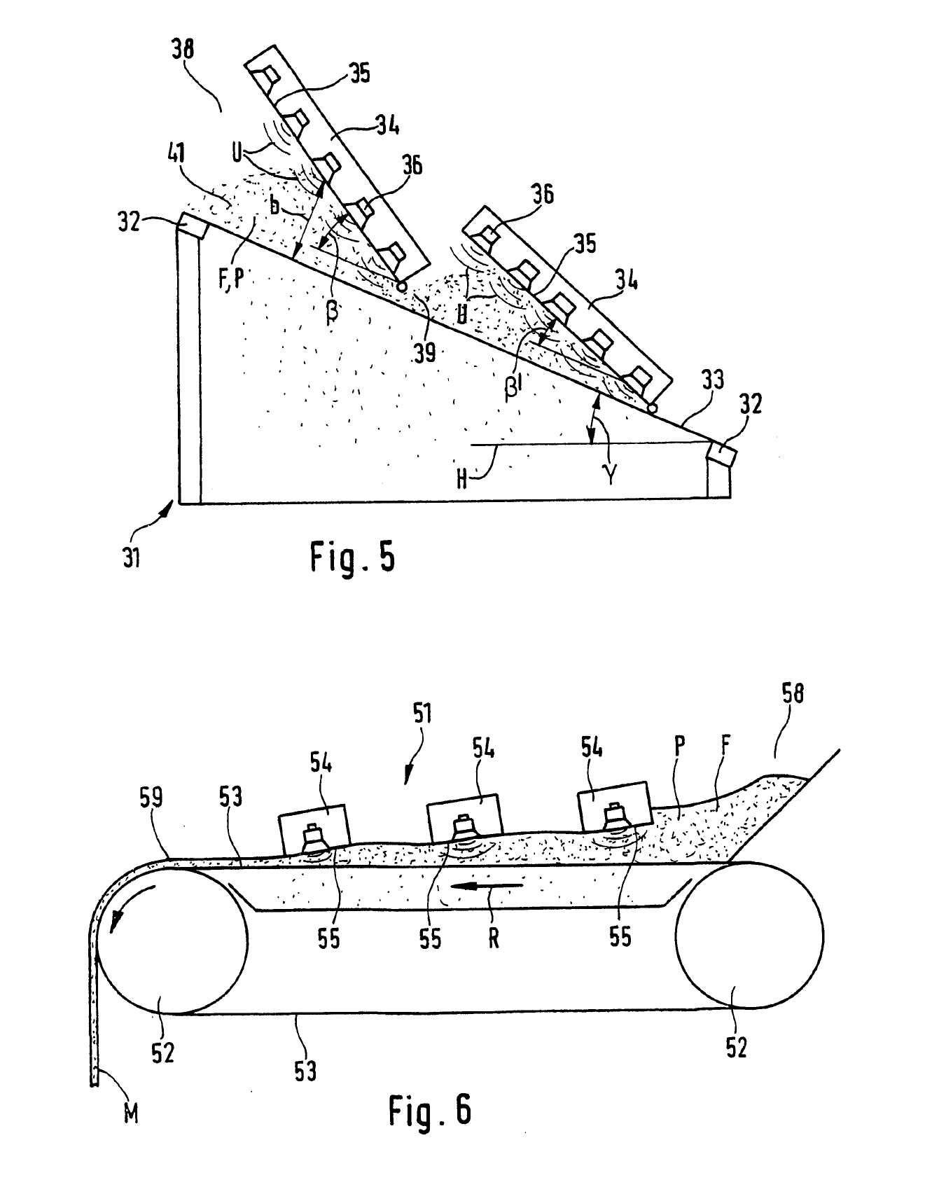

FIG. 5 schematically shows one alternative embodiment. The device is made as a static screening machine 31. A screen surface 31 is clamped on the screen frame 32 at an angle γ to the horizontal H. Above the screen surface 33 there are two ultrasonic arrangements 34. The liquid F to be screened, with particles P, is routed between the acoustic irradiation surface 35 of the ultrasonic arrangement 34 and the screen surface 33. The ultrasonic arrangements 34 are arranged to be adjustable so that the angles β, β′ between the acoustic irradiation surface 35 and the screen surface 33 can be adjusted, for example depending on the screen feed. FIG. 5 shows two ultrasonic arrangements 34. The material to be screened moves by gravity over the screen surface 33 from the feed opening 38 down to a discharge opening 39 and is exposed to ultrasonic vibrations U in doing so. The width b of the gap 41 between the screen surface 33 and the acoustic irradiation surface 35 decreases downward. The ultrasonic arrangement 34 which is the upper in FIG. 5 is located at a distance to the screen surface 33 so that unscreened material can move farther along the screen surface 3 where it is exposed to vibrations by the ultrasonic arrangement 34 which is the bottom one in FIG. 5.

The angles β, β′ can be set individually and can typically be 5-15°.

FIG. 6 shows another alternative embodiment of the device as claimed in the invention. The device 51 has two rotationally mounted rollers 52. A closed flexible screen 53 is clamped on the rollers 52. By turning the rollers the screen 53 can be moved in the direction R with a speed of roughly 0.5-3 m/min. The particles P to be screened in the liquid F are delivered to the screen 53 at the material feed 58. As a result of the motion of the screen 53 the liquid F is conveyed with particles P in the direction of the ultrasonic arrangements 54 which are provided with acoustic irradiation surfaces 55. Between the acoustic irradiation surfaces 55 and the screen surface 53 a gap is formed with a width which decreases in the direction R from the material feed 58 to the material discharge 59. Material M which cannot be screened is removed as a result of the motion of the screen surface 53 at the material discharge 59 from the screen surface 53. In addition, there can be stripping mechanisms such as doctor blades which remove the particles M which cannot be screened from the screen surface 53.

The screened material is captured underneath the screen in a trough. The trough can be tilted for example so that the screened material flows away.

1-22. (canceled)

23. A device for screening, classifying, sifting, filtering or sorting particles contained in a liquid, said device comprising
at least one screen frame having a screen surface to which the liquid containing the particles can be applied,
at least one ultrasonic arrangement for delivering ultrasonic vibrations into the liquid,
wherein the ultrasonic arrangement has an acoustic irradiation surface which can be brought into contact with the liquid on the screen surface and at least one ultrasonic transducer for vibrating said surface, at least the ultrasonic transducer being located on a side facing away from the liquid.

24. A device as claimed in claim 23, wherein substantially all of the screen surface is covered by the acoustic irradiation surface.

25. A device as claimed in claim 23, wherein the screen surface is substantially round and the ultrasonic arrangement is made substantially rotationally symmetrical with respect to an axis perpendicular to the screen surface.

26. A device as claimed in claim 23, wherein the ultrasonic arrangement has a feed opening for the liquid.

27. A device as claimed in claim 26, wherein a gap is formed between the screen surface and the acoustic irradiation surface, the gap having a width decreasing away from the feed opening for the liquid, toward at least one discharge opening for material which cannot be screened.

28. A device as claimed in claim 27, wherein the gap between the screen surface and the acoustic irradiation surface has a width which decreases from the middle of the ultrasonic arrangement radially towards the outer edge.

29. A device as claimed in claim 27, wherein the discharge opening is made as an opening in the peripheral outside wall of the ultrasonic arrangement.

30. A device as claimed in claim 23, wherein the ultrasonic arrangement is or can be detachably connected to a screening machine.

31. A device as claimed in claim 23, further comprising means for measuring or controlling liquid level on the screen surface.

32. A device as claimed in claim 23, wherein the screen surface is tilted relative to the horizontal and wherein the acoustic irradiation surface is flat and runs at an angle to the screen surface.

33. A device as claimed in claim 23, wherein the distance and/or the angle between the acoustic irradiation surface and the screen surface is adjustable.

34. A device as claimed in claim 23, wherein the screen surface is movable relative to said at least one ultrasonic arrangement.

35. A device as claimed in claim 34, wherein the acoustic irradiation surface is located at an angle to the screen surface so that the width of the gap between the screen surface and the acoustic irradiation surface decreases from material feed to material discharge, the screen surface being movable in a direction between material feed and material discharge.

36. A device as claimed in claim 34, wherein the screen surface is a closed, flexible screen which is clamped on two rotationally supported rollers.

37. An ultrasonic arrangement for a device as claimed in claim 23, wherein the ultrasonic arrangement has an acoustic irradiation surface which can be brought into contact with the liquid,

38. An ultrasonic arrangement as claimed in claim 37, wherein the ultrasonic arrangement is seated on the screen frame of a conventional screening machine.

39. An ultrasonic arrangement as claimed in claim 37, wherein the acoustic irradiation surface runs roughly conically, and is made of component surfaces which are at an angle to one another.

40. A process for screening, classifying, sifting, filtering or sorting of particles contained in a liquid on a screen surface, said process comprising steps of
delivering ultrasonic vibrations into the liquid by means of an ultrasonic arrangement having an acoustic irradiation surface which can be brought into contact with the liquid, and
vibrating the acoustic irradiation surface with at least one ultrasonic transducer located on a side of the acoustic irradiation surface facing away from the liquid.

41. A process as claimed in claim 40, wherein the liquid with the particles is routed through a gap between the acoustic irradiation surface and the screen surface.

42. A process as claimed in claims 40, wherein the level of the liquid on the screen surface is measured and/or controlled.

43. A process as claimed in claims 40, wherein the screen surface is moved during the screening process.

44. A process as claimed in claim 43, wherein the screen surface is moved from the material feed in the direction of the material discharge.
